(19) United States
(12) Patent Application Publication
(10) Pub. No.: US 2013/0205373 A1
(43) Pub. Date: Aug. 8, 2013

(54) ADAPTING AUTHENTICATION FLOW BASED ON WORKFLOW EVENTS

(71) Applicant: Aventura HQ, Inc., Denver, CO (US)

(72) Inventors: Joe Jaudon, Sedalia, CO (US); David Lowrey, Denver, CO (US); Adam Williams, Aurora, CO (US)

(73) Assignee: Aventura HQ, Inc., Denver, CO (US)

(21) Appl. No.: 13/782,844

(22) Filed: Mar. 1, 2013

Related U.S. Application Data
(63) Continuation-in-part of application No. 13/368,954, filed on Feb. 8, 2012.

(51) Int. Cl. H04L 29/06

(52) U.S. Cl. CPC H04L 63/08
USPC 726/4

(57) ABSTRACT

Systems, devices, and methods are disclosed for managing virtual sessions. A plurality of workflow events may be received at a central server computer system from a plurality of different terminal devices. A context of a user associated with a virtual session at the central server computer system may be determined, and an authentication flow for the user may be determined based on the context of the user and at least one of the received workflow events. The user may be authenticated for access to the virtual session at a terminal device according to the determined authentication flow.

### CROSS REFERENCES

The present application is a continuation-in-part of U.S. patent application Ser. No. 13/368,954, entitled “PRE-ACCESS LOCATION-BASED RULE INITIATION IN A VIRTUAL COMPUTING ENVIRONMENT” and filed on Feb. 8, 2012, which is incorporated herein by reference in its entirety for all purposes.

### BACKGROUND

The present invention relates to computer network communication, and more particularly, to updating resource access permissions in a virtual computing environment.

Various computer systems may use a thin-client or a virtual desktop display in conjunction with a centralized server computer system or mainframe. Virtualization is a logical representation of a computer in software. By decoupling the physical hardware from aspects of operation, virtualization may provide more operational flexibility and increase the utilization rate of the underlying physical hardware. Although virtualization is often implemented in software, many modern microprocessors now include hardware features explicitly designed to improve the efficiency of the virtualization process.

A virtual desktop display can be served to client devices from a central or distributed server computer system. The server may receive input and output over a network or other communication medium established between the device and the server. In some examples, a thin-client device may run web browsers or remote desktop software, such that significant processing may occur on the server.

In many instances, roaming users may be delayed as they transition to new applications when they move to new locations. This wait time may be due to re-authentication requirements, which can significantly impact productivity and efficiency. Thus, there may be a need in the art to reduce wait periods as users roam and transition in and out of different workflows.

### SUMMARY

Methods, systems, and devices are described for managing virtual sessions by dynamically adapting authentication flows based on distributed workflow events received at a central system.

According to a first set of illustrative embodiments, a method of managing virtual sessions may include receiving a plurality of workflow events at a central server computer system from a plurality of different workflow devices; determining a context of a user associated with a virtual session at the central server computer system; dynamically updating an authentication flow for the user based on the context of the user and at least one of the received workflow events; and authenticating the user for access to the virtual session at a workflow device according to the determined authentication flow.

In certain examples, the dynamically updating the authentication flow may include: selecting between a single-factor authentication flow and a dual-factor authentication flow for the user based on the received workflow events. In certain examples, the received workflow events may be compared to a stored sequence of workflow events, and a determination may be made that the received workflow events match the stored sequence of workflow events. In certain examples, an authentication rule associated with the stored sequence of workflow events may be triggered based on the determined match.

In certain examples, the stored sequence of events may include a time constraint associated with a receipt of at least two of the workflow events in the stored sequence of workflow events. In certain examples, at least one action associated with the virtual session may be identified based at least in part on the received workflow events, and the virtual session may be dynamically updated based on the at least one action. The virtual session may be dynamically updated based on the at least one action prior to completing the authentication of the user.

In certain examples, at least one of the workflow events from which the authentication flow is selected comprises a workflow event associated with a second user and a second virtual session. In certain examples, the received workflow events may include at least one workflow event indicating that an access token associated with the user has been received at a workflow device in communication with one of the terminal devices.

In certain examples, session data for the virtual session may be selectively transmitted between the central server computer system and the one of the terminal devices in response to the authentication of the user.

According to a second set of illustrative embodiments, a central server computer system configured to manage access tokens may include: a workflow event receiving module configured to receive a plurality of workflow events at a central server computer system from a plurality of different workflow devices; a user context module configured to determine a context of a user associated with a virtual session at the central server computer system; an authentication flow module configured to dynamically update an authentication flow for the user based on the context of the user and at least one of the received workflow events; and a user authentication module configured to authenticate the user for access to the virtual session at a workflow device according to the determined authentication flow. The central server computer system may be configured to perform any of the functionality described above with respect to the first set of illustrative embodiments.

According to a third set of illustrative embodiments, a computer program product may include a tangible computer readable device comprising computer readable instructions stored thereon. The computer readable program instructions may include: computer readable program instructions configured to receive a plurality of workflow events at a central server computer system from a plurality of different workflow devices; computer readable program instructions configured to determine a context of a user associated with a virtual session at the central server computer system; computer readable program instructions configured to dynamically update an authentication flow for the user based on the context of the user and at least one of the received workflow events; and computer readable program instructions configured to authenticate the user for access to the virtual session at a workflow device according to the determined authentication flow. The computer program product may be configured to cause at least one processor to perform any of the functionality described above with respect to the first set of illustrative embodiments.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIGS. 2A-2C are diagrams of an example system including components configured according to various embodiments of the invention.

FIG. 3 is a diagram of an example system including components configured according to various embodiments of the invention.

FIG. 4 is a block diagram of a central server computer system including components configured according to various embodiments of the invention.

FIGS. 5 is a block diagram of a central server computer system including components configured according to various embodiments of the invention.

FIG. 6 is a flowchart diagram of an example method of virtual session management according to various embodiments of the invention.

FIG. 7 is a flowchart diagram of an example method of virtual session management according to various embodiments of the invention.

FIG. 8 is a flowchart diagram of an example method of virtual session management according to various embodiments of the invention.

FIG. 9 is a schematic diagram that illustrates a representative device structure that may be used in various embodiments of the present invention.

### DETAILED DESCRIPTION OF THE INVENTION

Methods, systems, and devices are disclosed for managing virtual sessions by dynamically adapting an authentication flow based on workflow events. Certain actions or conditions associated with a user's workflow may trigger workflow events to be received by or generated at one or more terminal devices. These terminal devices may transmit the workflow events to a central server computer system. Based on the combination of workflow events and a context associated with a virtual session of the user, the central server computer system may require more or fewer credentials from the user to allow the user to access the virtual session. Certain workflow event patterns or signatures may cause the central server computer system to associate the virtual session with a particular terminal device before the user even begins to use that terminal device, thereby decreasing the user's wait time at that terminal device to access the virtual session.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

As used herein, the term “workflow event” refers to a discrete electronic record, generated at a terminal device, of a detected user action, environment, or condition.

As used herein, the term “workflow device” refers to an electronic device configured to generate workflow events for transmission to a central system or service. Examples of such workflow devices include, but are not limited to, terminal devices, sensors, mobile devices, timers, or other devices that detect user actions, environments, or conditions.

As used herein, the term “terminal device” refers to a device configured to provide a user interface for a remotely hosted virtual session to a user associated with the virtual session. A “terminal device” may be, for example, a personal programmable device or a shared programmable device.

As used herein, the term “access token” or “token” refers to a digital representation of an authentication credential (e.g., proximity card data, magnetic card swipe, Personal Identification Number (PIN) or other user identifier, username, password, Near Field Communications (NFC) data, biometric data, etc.) as received at a workflow device.

As used herein, the term “virtual session” or “session” refers to a hosted session of a virtual computing environment associated with a particular user that may be accessed from one or more client devices other than the host. For example, a session may include a thin client session, a virtual application session, a virtual machine session, a virtual operating system session, and/or the like. As used herein, a session described as being “between” a host device and a terminal device refers to the exchange of data between the host device and the terminal device, where the data is related to the session hosted at the host device.

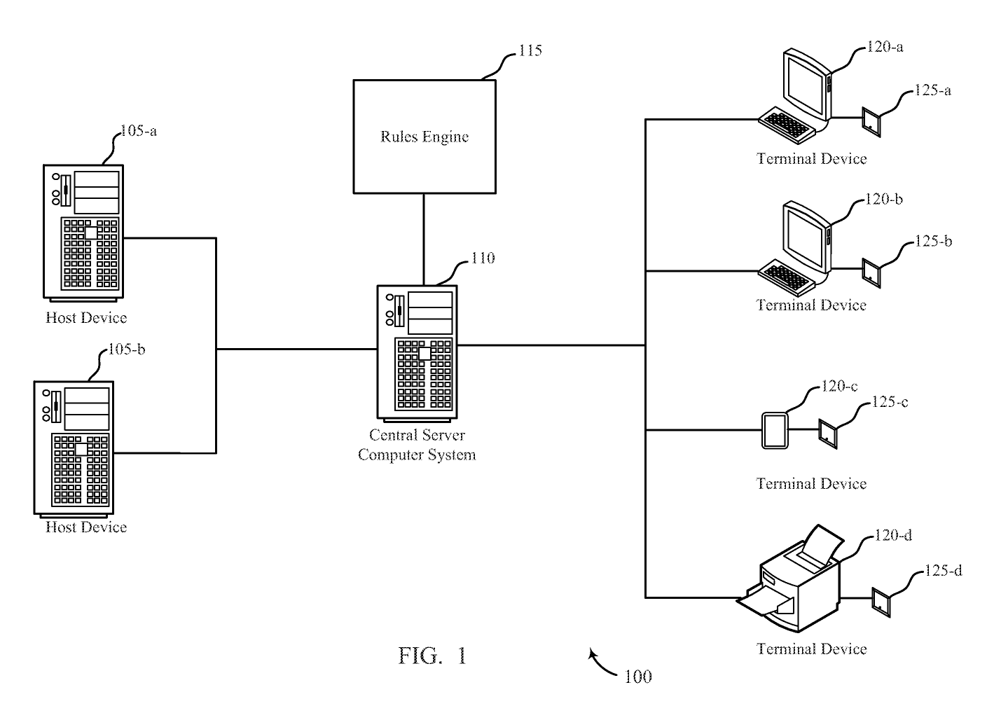

FIG. 1 illustrates an example system 100 including host devices 105, a central server computer system 110, a rules engine 115, terminal devices 120 (e.g., workstation 120-a, workstation 120-b, smartphone 120-c, and printer 120-d), and workflow devices 125 (e.g., proximity card readers 125). Each of these components may be in communication, directly or indirectly.

In the system 100 of FIG. 1, the central server computer system 110 may be communicatively coupled with a number of host devices 105 and terminal devices 120. The central server computer system 110 may be configured to forward network packets between the host devices 105 and the terminal devices 120. The central server computer system 110 may be implemented by a single server device or by a number of related components interconnected over a network. A single host device 105 may include one or more servers. Each of the host devices 105 may be configured to provide one or more services. These services may vary in scope and function.

In one example, a number of host devices 105 may host virtual sessions on behalf of users of the terminal devices 120. Each virtual session hosted at a host device 105 may be associated with a particular user. A user may access a session hosted by a host device 105 through one of the terminal devices 120. A terminal device 120 may function as a thin client, and the host device 105-a may provide operating system functionality remotely to the terminal device 120 while the terminal device 120 provides keyboard, video, and mouse (KVM) functionality for the session to the user. Alternatively, the terminal device 120 may execute the operating system based on settings provided for the user from the host device 105.

Each of the workflow devices 125 may be configured to generate workflow events based on user actions or conditions. In the present example, the workflow devices 125 are proximity card readers. Alternatively, one or more of the workflow devices 125 may include biometric readers, keypads, magnetic card readers, wireless transceivers for communicating with mobile devices, or other types of workflow devices. When a user provides an access token to a proximity card reader workflow device 125, rather than processing of the received access token only in the operating system of the terminal device 120 associated with the proximity card reader workflow device 125, the terminal device 120 may generate a workflow event and transmit the workflow event to the central server computer system 110.

The central server computer system 110 may apply a set of rules from the rules engine 115 to the workflow event to determine one or more appropriate actions to take based on the workflow event. The central server computer system 110 may then take the appropriate action or instruct a terminal device 120 or host device 105 to take the appropriate action. Thus, through the centralized virtualization of the workflow event processing, the workflow event generated at a local terminal device 120 may affect other terminal devices 120, one or more of the host devices 105, or the central server computer system 110.

In one example, a user of a terminal device 120 may log onto a system by providing a first access token to the proximity card reader workflow device 125 associated with a terminal device 120 (e.g., by tapping a key card to a reader associated with a terminal workstation). As described above, the terminal device 120 may transmit a workflow event indicating the receipt of the first access token to the central server computer system 110 for processing. In certain examples, the workflow event may include the access token received at the workflow device 125.

The central server computer system 110 may apply a set of rules at rules engine 115 to identify the user based on the received workflow event and determine that a virtual session is currently being hosted for the user at a host device 105-a. Based on the set of rules and the received workflow event, the central server computer system 110 may instruct the terminal device 120 to prompt the user for further credentials to authenticate the user, update the existing virtual session at the host device 105 based on the location of the terminal device 120, prepare to switch KVM data for the session to the terminal device 120, and instruct another terminal device 120 previously associated with the virtual session to log the user out. Once the user completes the authentication process, the virtual session associated with the user may immediately appear on the terminal device where the user is currently located.

In certain examples, at least a portion of the rules engine 115 may be implemented by or within the central server computer system 110. Additionally or alternatively, at least a portion of the rules engine 115 may be implemented by a device external to the central server computer system 110. The rules engine 115 may apply or enforce a set of event-based rules for authenticating users, dynamically modifying authentication rules and/or other aspects of the virtual sessions, creating and tearing down virtual sessions, and multiplexing the session data between the host devices 105 and the terminal devices 120. The central server computer system 110 may selectively forward session data between the host devices 105 and the terminal devices 120 based on the logical deductions of the rules engine 115.

In certain examples, devices in addition to or instead of proximity card readers may operate as workflow devices 125 to generate workflow events for transmission to and processing by the central server computer system 110. For example, one or more sensors (e.g., temperature, motion, touch, light, location, etc.) or timers may generate workflow events based on detected events, conditions, or times. In certain examples, terminal devices 120 may generate workflow events based on attempts to log on to the terminal devices, time spent on the terminal device, applications or programs used, virtual session information, files accessed, idle or active time, or other conditions or actions arising at the terminal devices 120.

As discussed above, each workflow event generated at a workflow device 125 may be transmitted to the central server computer system 110 for processing. In certain examples, the central server computer system 110 may be configured to recognize certain sequences of workflow events occurring within a predetermined time windows in association with a particular user or a particular virtual session associated with a user. The rules engine 115 may apply a set of rules to detected sequences of workflow events at the central server computer system 110 to dynamically adapt authentication flows for users attempting to access virtual sessions managed by the central server computer system 110 from terminal devices 120.

As will be explained in more detail below, certain sequences of workflow events may indicate that a particular user is trusted, and the authentication process may be less rigorous (e.g., single-factor authentication) for the user based when such a sequence of workflow events is detected at the central server computer system 110. By contrast, certain sequences of workflow events may indicate that a particular user is less trusted, and the central server computer system 110 may elevate the amount of authentication required from that user in order to access a virtual session.

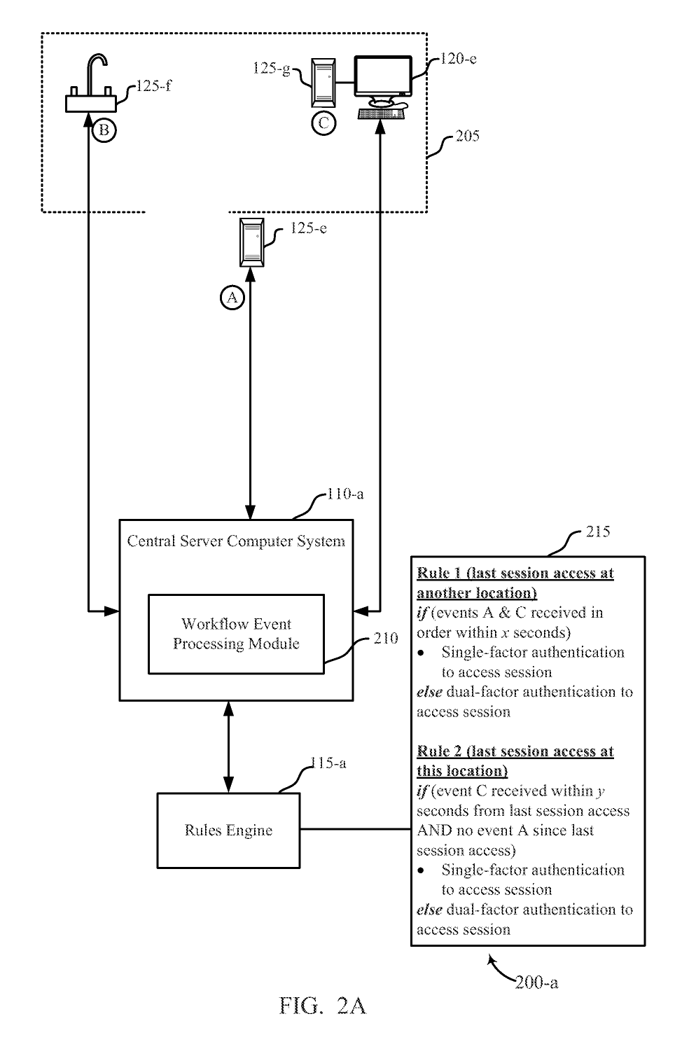

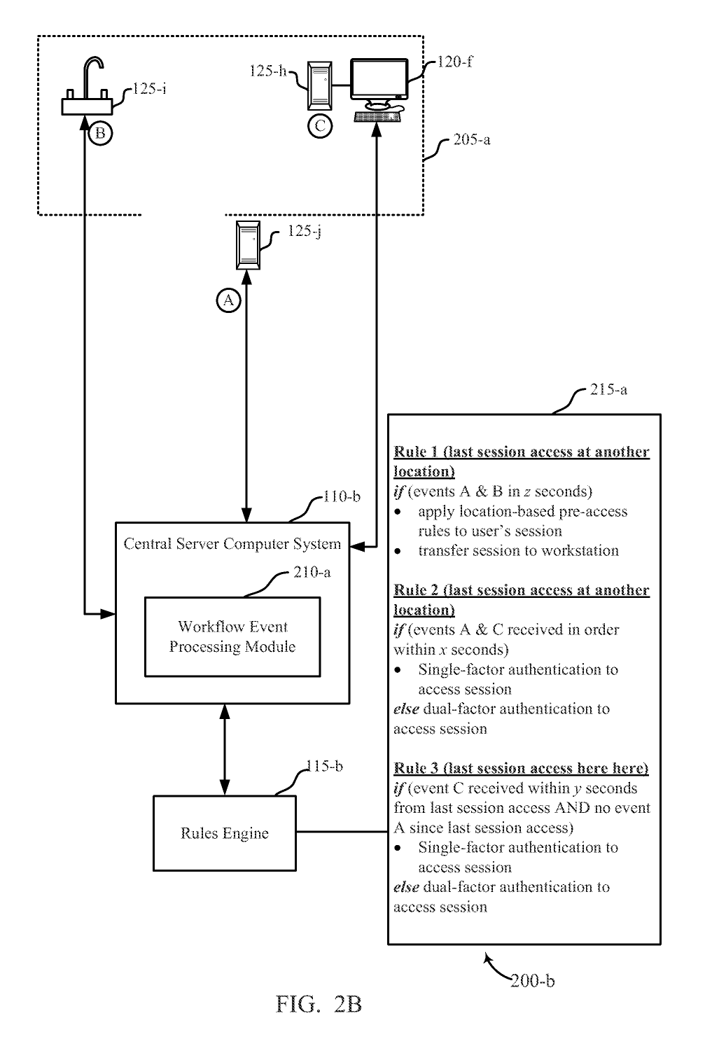

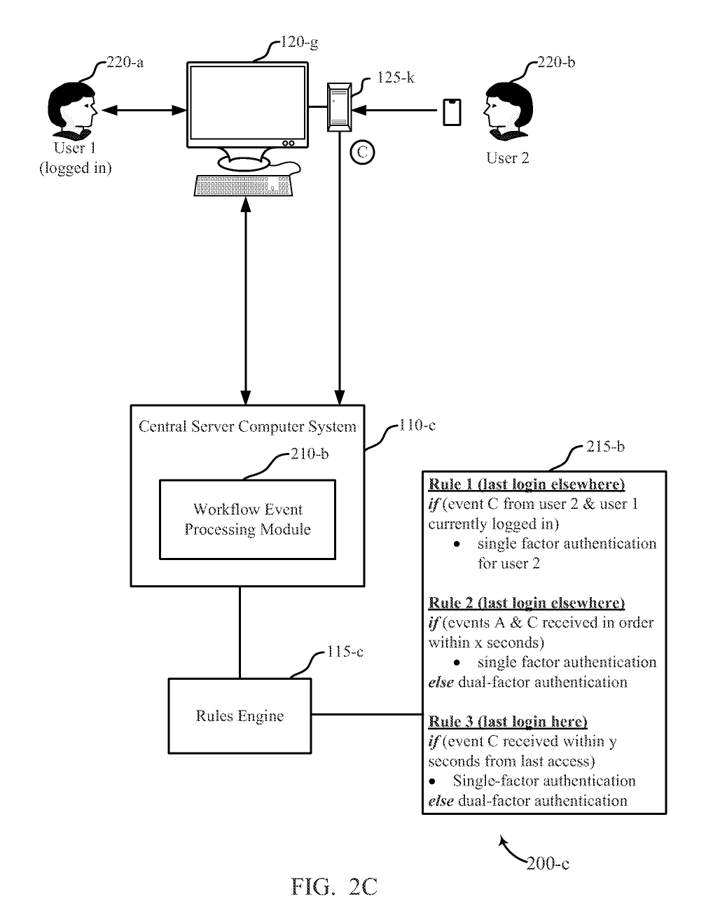

FIGS. 2A-2C show examples of a system 200 in which an authentication flow is dynamically adapted for a user based on workflow events according to the principles of the present disclosure. The system 200 may include a central server computer system 110-a, rules engine 115-a, terminal device 120-e, and workflow devices 125 (e.g., access card readers 125-e and 125-g, and sink sensor 125-f). The system 200 of FIG. 2 may be an example of the system 100 of FIG. 1.

The central server computer system 110-a may be communicatively coupled with the workflow devices 125, and may receive workflow events generated by the workflow devices over a network. In certain examples, one or more workflow devices (e.g., workflow device 125-e) may be peripherally connected to a terminal device (e.g., terminal device 125-e) configured to forward workflow events from the workflow device to the central server computer system 110-a. Alternatively, one or more workflow devices 125 (e.g., workflow devices 125-f, 125-g) may be configured to autonomously generate and forward workflow events to the central server computer system 110-a over the network. Such workflow devices 125 may function as standalone terminal devices or as independent network peripherals.

In the present example, the workflow devices 125 are associated with a location 205. It will be understood that additional workflow devices (not shown) may be present in the system 200, including additional workflow devices associated with location 205, additional workflow devices associated with other locations, and/or additional workflow devices that are not tied to a particular location. For the sake of clarity in explanation, the operation of the present system 200 will be described in the context of the three workflow devices 125e, 125-f, 125-g tied to location 205.

Workflow device 125-g may be disposed at a point of entry to location 205. Workflow device 125-g may detect proximity cards or other physical authentication credentials and generate workflow event A for transmission to the central server computer system 110-a upon receiving authentication credentials from a user. Workflow device 125-f may be a sensor integrated into a sink such that workflow event B is generated for transmission to the central server computer system 110-a whenever the water is turned on at the sink. Workflow device 125-g may detect proximity cards or other authentication credentials from users attempting to access terminal device 120-e and generate workflow event C for transmission to the central server computer system 110-a whenever such credentials are received.

The central server computer system 110-a may include a workflow event processing module 210 configured to detect patterns or sequences of workflow events received from the workflow devices 125 and dynamically alter certain aspects of one or more virtual sessions to update the virtual sessions based on the detected patterns or sequences of workflow events. The workflow event processing module 210 may coordinate with rules engine 115-a to apply a set of one or more workflow event-based rules 215 to dynamically update the virtual sessions.

By way of example and not limitation, the system 200 may be deployed in a health care facility, and location 205 may correspond to an individual examination room. Physicians, nurses, and other personnel may move from examination room to examination room to examine different patients. The central server computer system 110-a may maintain a separate virtual session for each physician or nurse currently on duty at the facility, and each physician or nurse may access his or her virtual session from the terminal device 120 in each room. Workflow protocol at the facility may provide for each physician or nurse entering an examination room to tap his or her proximity card at an access card reader near the entrance to the examination room.

Thus, in the context of FIGS. 2A-2C, as a physician or nurse user enters location 205, the user may provide an authentication credential to workflow device 125-e, which may forward workflow event A to the central server computer system 110-a. The physician or nurse user may then wash his or her hands at the sink, which may cause workflow device 125-f to forward workflow event B to the central server computer system 110-a. After using the sink, the physician or nurse user may provide an authentication credential at workflow device 125-g to begin logging on to his or her virtual session at the terminal device 120-e, which may cause terminal device 120-e to forward workflow event C to the central server computer system 110-a.

The central server computer system 110-a may leverage this typical sequence of events to reduce the amount of time spent by the user to log on to his or her virtual session at the terminal device 120-e. For example, the central server computer system 110-a may treat the receipt of workflow events A, B, and C in sequence and within predetermined time windows as an indication of the user's identity. Accordingly, if the central server computer system 110-a receives workflow events A, B, and C according to the designated order and timing, and if the user has recently provided dual-factor authentication to the central server computer system 110-a, the user may only have to provide single-factor authentication (e.g., access card tap) to access his or her session at workstation 120-e instead of the default dual-factor authentication (e.g., access card and password).

The system 200-a of FIG. 2A illustrates the principle of dynamically adapting authentication flow for a user based on received workflow events. In FIG. 2A, the rules engine 115-a may be configured to implement authentication rules related to virtual sessions from terminal device 120-e.

Different rules may be applicable to different scenarios. Thus, in the present example, Rule 1 may be applicable to users whose most recent session access occurred somewhere other than location 205. Under Rule 1, if the user taps his or her access card at workflow device 125-e and then again at workflow device 125-g within a predefined number (x) of seconds, the user may gain access to his or her virtual session at terminal device 120-e without being prompted to enter a password (i.e., single-factor authentication). Otherwise, the user may be required to enter a password at terminal device 120-e in connection with the access card tap at workflow device 125-g (i.e., dual-factor authentication) to log in to or otherwise access his or her virtual session.

Rule 2 may be applicable to users whose most recent session access occurred at location 205. Under Rule 2, if the user taps his or her access card at workflow device 125-e within y seconds from his or her last session access without generating event C since the last session access, the user may gain single-factor authentication access to his or her virtual session at terminal device 120-e without being prompted to enter a password (i.e., single-factor authentication). Otherwise, the user may be required to enter a password at terminal device 120-e in connection with the access card tap (i.e., dual-factor authentication) at workflow device 125-g to log in to or otherwise access his or her virtual session.

In certain examples, the rules engine 115-a and central server computer system 110-a may enforce dual-factor authentication from the user if a certain amount of time has passed since the user provided dual-factor authentication to the central server computer system 110-c. Thus, a user logging on to his or her virtual session for the first time during a shift or workday may be prompted to provide dual-factor authentication to access his or her virtual session, and then only provide single-factor authentication to access his or her virtual session at different locations throughout the shift or workday in compliance with Rules 1 and 2. Nevertheless, following the end of the shift, workday, or another period, the user's dual factor authentication may expire, and the user may be prompted again to enter dual-factor authentication to access the session despite the single-factor provisions of Rules 1 and 2.

Rules 1 and 2 of FIG. 2A, as implemented by the workflow event processing module 210 and the rules engine 115-a, may reduce the authentication flow associated with gaining access to a user's virtual session if the user's workflow behavior produces an expected sequence of workflow events at the central server computer system 110-a. This reduction in authentication flow may save the user time and allow the user to work more efficiently.

In addition, Rules 1 and 2 of FIG. 2A may prevent access to the user's virtual session by unauthorized users. To illustrate this point, consider again the example in which the system 200 of FIG. 2A is deployed in a health care facility, and location 205 corresponds to an individual examination room. A nurse may log out of his or her virtual session in a different examination room (not shown) and accidentally drop his or her access card in a hallway. A patient may pick up the dropped access card, enter the examination room at location 205, and attempt to access the nurse's virtual session by tapping the access card to workflow device 125-g, thereby generating event C. However, because the nurse's virtual session originated outside of the examination room and the patient did not tap the access card at workflow device 125-e prior to tapping the access card at workflow device 125-g, Rule 1 may result in the patient receiving a prompt to enter the nurse's password at terminal device 120-e to gain access to the nurse's virtual session. Because the patient may not know the nurse's password, the patient may be denied access to the nurse's virtual session.

In another example, a nurse user may access his or her virtual session in the examination room associated with location 205. Upon finishing up with a patient in the examination room, the nurse may log out of his or her virtual session at terminal device 120-e and accidentally leave his or her access card in the examination room when the nurse exits the examination room. The patient, having noticed that the nurse always taps at his or her access card at workflow device 125-e prior to entering the examination room, may take the nurse's access card and tap in at workflow device 125-e, then go over to terminal device 120-e and tap in at workflow device 125-g. The last access to the nurse's virtual session having occurred at location 205, Rule 2 may apply. Accordingly, because the central server computer system 110-a received event A at location 205 following the last session access, the patient may be prompted to enter the nurse's password at terminal device 120-e to gain access to the nurse's virtual session. Because the patient may not know the nurse's password, the patient may be denied access to the nurse's virtual session.

FIG. 2B illustrates an example system 200-b in which a set of one or more pre-access rules may be applied to a virtual session of the user to dynamically update the user's virtual session prior to the user logging in to the virtual session at location 205-a. The one or more pre-access rules may be triggered based on a pattern of workflow events received at the central server computer system 110-b.

For example, the rules engine 115-b of FIG. 2B may enforce a Rule 1 such that if a user entering location 205-a taps at workflow device 125-j, generating workflow event A, and then begins washing his or her hands, thereby generating workflow event B within a predetermined amount (z) of seconds, a set of one or more location-based pre-access rules may be applied to the virtual session associated with the user to bind the virtual session to location 205-a and update various aspects of the virtual session based on location 205-a.

The location-specific rules may update one or more aspects, settings, and/or access permissions of the session, applicable to individual users, types of users, sessions, types of sessions, applications, specific client devices, types of devices, etc. The location-specific rules may apply to a particular terminal device, all terminal devices in an area, or certain types of terminal devices in an area. The aspects and settings of the session may, for example, relate to an appearance of a user interface for the session, the status of one or more applications within or associated with the session, the value of one or more session variables, the association of one or more printers or other default peripheral devices with the session, and/or the like. The access permission rules may relate to controlling, restricting, manipulating, or restricting resources. Resources may include applications, computing resources, network resources, system resources.

Various types of action may be initiated according to the one or more location-based pre-access rules. In certain examples, the action may be to allow or block access to a resource, such as, for instance, a folder in a network drive, an application, and/or a network. In additional or alternative examples, the action may be to create, open, close, or delete an application, a file, a user profile, a setting, or the like. In still other additional or alternative examples, the action may be to open or hide a certain aspect of the session. For instance, an application associated with the session may continue to run in the background, but the access permission rule may hide the application from the user, thereby preventing the user from viewing or access the running application through the session. Additionally or alternatively, the action may affect some other aspect of the user interface of the session, such as minimizing or maximizing a certain application, file, or folder; reordering the display of graphical elements in the session; moving graphical elements in the session; drawing certain graphical elements in the session; painting certain graphical elements in the session; filling certain graphical elements in the session; clearing certain graphical elements in the session; and/or coloring certain graphical elements in the session.

In additional or alternative examples, the action initiated according to the one or more location-based pre-access rules may include displaying certain text or graphics to the user, prompting the user to provide textual or other input to the session, and/or initiating communications via input/output (I/O) devices or ports. In still other additional or alternative examples, the action may include modifying a session variable based on the second location, associating or disassociating one or more printers or other peripheral devices with the session based on the second location, and/or modifying a security setting associated with the session based on the second location.

Rules 2 and 3 implemented by the rules engine 115-b of the example of FIG. 2B may substantially correspond to Rules 1 and 2 implemented by the rules engine 115-a of the example of FIG. 2A.

FIG. 2C illustrates an example system 200-c in which a rule may be enforced that allows a second user 220-b to access his or her virtual session at a terminal device 120-g with single-factor authentication when a first user 220-a is currently logged on to and accessing a different virtual session at the terminal device 120-g.

The rules engine 115-c of the example of FIG. 2C may enforce a Rule 1, which may cause the central server computer system 110-c to switch the virtual session associated with the second user 220-b to the terminal device 120-g and provide immediate access to the virtual session associated with the second user 220-b in response to the receipt of event C from the second user 220-b while the first user 220-a is logged in to terminal device 120-g. Rule 1 or similar rules may be specific to individual users (e.g., single-factor authentication at the terminal device 120-g for John is allowed when Michael is currently logged in to the terminal device 120-g), classes or types of users (e.g., single-factor authentication at the terminal device 120-g for a doctor is allowed when a nurse is currently logged in to the terminal device 120-g), relationships between individual users (e.g., single-factor authentication for a supervisor at terminal device 120-g is allowed when the supervisor's administrative assistance is logged in to the terminal device 120-g), or other scenarios.

In certain examples, Rule 1 or similar rules enforced by the rules engine 115-c and the central server computer system 110-c may be based on the presupposition that the first user 220-a knows and recognizes the second user 220-b, and that the first user 220-a would not permit a user unknown to the first user 220-a to access the terminal device 120-g while the first user 220-a is logged on to the terminal device 120-g.

Rules 2 and 3 implemented by the rules engine 115-c of the example of FIG. 2C may substantially correspond to Rules 1 and 2 implemented by the rules engine 115-a of the example of FIG. 2A, and to Rules 2 and 3 implemented by the rules engine 115-b of the example of FIG. 2B.

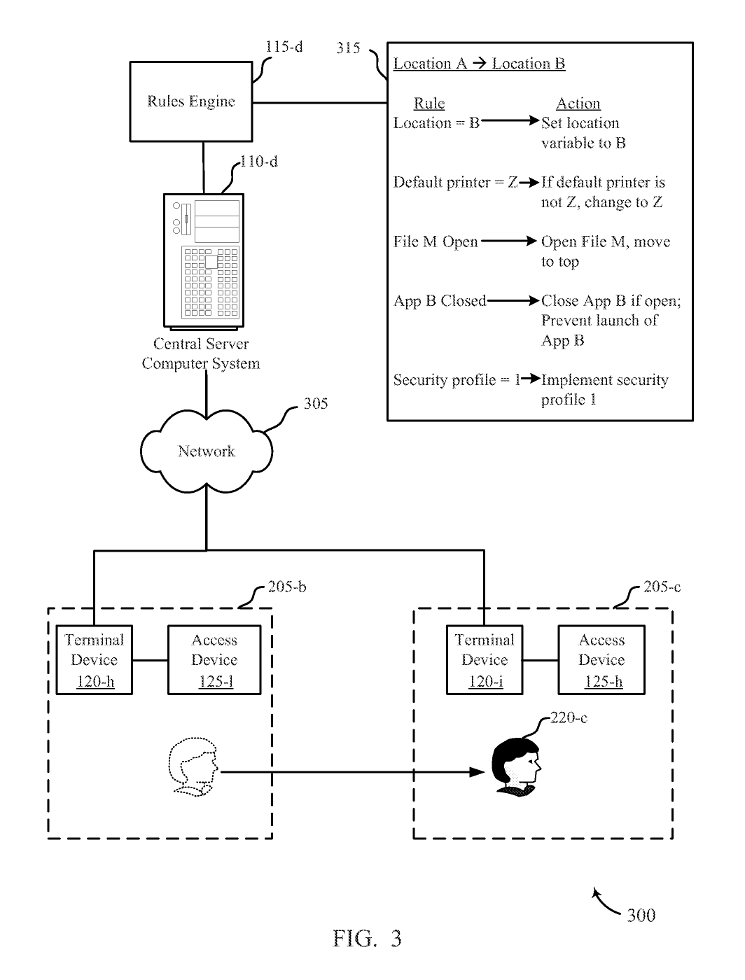

FIG. 3 is a block diagram illustrating an example of the application of pre-access location based rules to a virtual session in response to user movement between different locations in a system 300, consistent with the principles described above with respect to FIG. 2B. The system 300 of the present example may include a central server computer system 110-d, rules engine 115-d, network 305, terminal devices 120, and workflow devices 125. Each of these components may be in communication with each other, directly or indirectly. The system 300 may be an example of one or more of the systems 100, 200 described above with reference to FIG. 1 or FIGS. 2A-2C.

As shown in FIG. 3, the terminal devices 120 may be associated with different locations 205 or regions. Terminal device 120-h may be associated with location 205-a, while terminal device 120-i may be associated with location 205-c. In additional or alternative examples, one or more terminal devices 120 may be associated with other locations 205 (not shown). Each location 205 may be associated with a set of pre-access rules. The set of pre-access rules associated with each location 205 may vary with different users or may remain static for all users.

In the present example, user 220-c may initially log on to terminal device 120-h at location 205-b. One or more authentication credentials may be provided by the user 220-c at terminal device 120-h to access a virtual session associated with the user. The amount of authentication credentials provided by the user 220-c to log in to the virtual session at terminal device 120-h may be determined based on a set of rules enforced by the rules engine 115-d, as discussed in more detail with respect to the earlier Figures. The terminal device 120-h may forward the authentication credential(s) to the central server computer system 110-b for authentication of the user 220-c. In connection with the authentication of the user 220-c at terminal device 120-h, the central server computer system 110-d may associate a new or existing virtual session for the user 220-c with terminal device 120-h such that the central server computer system 110-d may host the virtual session and the and terminal device 120-h may provide keyboard/video/mouse (KVM) functionality for the virtual session to the user 220-c.

As further shown in FIG. 3, the user 220-c may, after a period of time accessing the session through terminal device 120-h, log off of terminal device 120-h and physically move to location 205-c. After the user 220-c has logged off of terminal device 120-h, the virtual session generated for the user 220-c may be maintained by the central server computer system 110-d (e.g., for a specified period of time, until a predetermined trigger event occurs, or indefinitely). In this way, when the user 220-c logs on to terminal device 120-i in location 205-c, a new session need not be built from scratch. Rather, the KVM functionality for the existing session already associated with the user 220-c may be switched to terminal device 120-i following authentication of the user 220-c at location 205-c.

In connection with moving to location 205-c, the user 220-c may interact with one or more workflow devices 125 to generate a sequence of workflow events that may be received by the central server computer system 110-d. The sequence of workflow events may be recognized at the central server computer system 110-d, and based on this recognition, the central server computer system 110-d may determine that the user 220-c has moved to location 205-c, associate the virtual session of the user 220-c with location 205-c and apply a set of location-based rules 315 to the virtual session to update one or more aspects of the virtual session before the user 220-c has logged on to the virtual session at location 205-c. In this way, delays associated with transferring the virtual session to the new terminal device 120-i and updating the virtual session based on the new location 205-c may be reduced, and the user 220-c may gain quicker access to the virtual session following authentication.

As shown in the example of FIG. 3, the set of location-based pre-access rules 315 for user 220-c at location 205-c may include a first rule for changing a location variable of the virtual session to B, a second rule for setting the default printer associated with the virtual session to X, a third rule for displaying application A as a top window in the user interface of the virtual session, a fourth rule for hiding application B in the user interface of the virtual session, and a fifth rule for setting the security profile of the virtual session to 3.

Each of the pre-access rules 315 may be associated with one or more actions. In the present example, the first rule may be associated with the action of setting the location variable for the session to B. The second rule may be associated with the action of setting the default printer for the session to X if X is not already the default printer. The third rule may be associated with the action of launching application A if application A is not open, and moving application A to the top of the user interface. The fourth rule may be associated with the action of hiding application B if application B is open, and preventing the launch of application B if application B is not open. The fifth rule may be associated with the action of implementing security profile 3 at the virtual session.

In certain examples, the central server computer system 110-d may prevent the user 220-c from accessing his or her existing virtual session at location 205-c until each of the actions associated with applying the location-based pre-access rules 315 has been completed with respect to the existing session. Such may be the case where certain critical access permissions are to be updated based on the change in location. In many cases, critical updates to the virtual session may take place before the user 220-c attempts to log on to the virtual session, based on the workflow events received at the central server computer system 110-d prior to the user 220-c attempting to log on to the virtual session at terminal device 120-i.

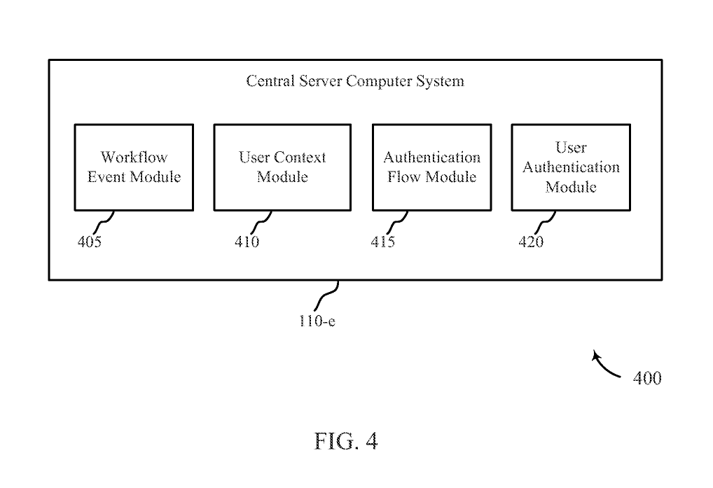

FIG. 4 is a block diagram 400 of an example central server computer system 110-e according to the principles described herein. The central server computer system 110-e may include a workflow event module 405, a user context module 410, an authentication flow module 415, and a user authentication module 420. Each of these modules may be in communication with each other module, directly or indirectly. The central server computer system 110-e may be an example of one or more of the central server computer systems 110 described above with reference to the previous Figures. In certain examples, the modules 405, 410, 415, 420 may be implemented as part of the workflow event processing module 210 of FIG. 2.

Each module 405, 410, 415, 420 may be implemented by dedicated hardware, processor hardware executing software, software stored on a physical computer-readable medium or device, or combinations thereof In certain examples, the same hardware may implement more than one of the modules 405, 410, 415, 420 of FIG. 4. Additionally or alternatively, the functionality of the modules 405, 410, 415, 420 of the central server computer system 110-e may be distributed across a system of interrelated hardware devices.

The workflow event module 405 may be configured to receive a workflow event from one or more different terminal devices over a network connection. The workflow events received at the workflow event module 405 may be generated by the terminal devices themselves or generated at workflow devices and forwarded from the workflow devices to the central server computer system 110-e by the terminal devices. The workflow events may indicate detected user actions, detected environmental conditions, timer expirations, or other detected occurrences or conditions.

The user context module 410 may determine a context of an individual user associated with at least one of the workflow events. In certain examples, the user context may be based on stored user context data for that user. Additionally or alternatively, the user context data may include context data derived from one or more of the workflow events. The user context may include, for example, the last known actions performed by the user, a current location of the user, whether the user has a virtual session, a configuration of the user's virtual session, a current location associated with the user's virtual session, a location associated with the user's last access to the virtual session, a login status of the user, a last terminal device accessed by the user, an activity level of the user, a security level of the user, an identity of the user, a relationship of the user to one or more other users, an identity or classification of another user logged into or near a terminal device at the location of the user, and/or other relevant information about the user or a virtual session of the user.

The authentication flow module 415 may be configured to dynamically update an authentication flow for the user based on the context of the user and at least one of the received workflow events. In certain examples, dynamically updating the authentication flow may include selecting between a single-factor authentication flow and a dual-factor authentication flow for the user based on the received workflow events and the context of the user. For example, as described in the examples of FIGS. 2A-2C, the authentication flow module 415 may determine the context information of whether the user last accessed a virtual session associated with the user at a current location of the user or at a different location, and based on that context information and the sequence of workflow events received, the authentication flow module 415 may determine whether to call for single- or dual-factor authentication from the user for access to a new or existing virtual session of the user.

In certain examples, the authentication flow module 415 may compare the received workflow events to a known or otherwise stored sequence of workflow events to select the number of authentication factors or amount of authentication information to be received from the user for access to the virtual session of the user. In certain examples, the known or stored sequence of workflow events may define a time window during which receipt of two or more of the workflow events may occur to match the known or stored sequence.

In certain examples, at least one rule-based action associated with the virtual session of the user may be identified based at least in part on the received workflow events, and the virtual session of the user may be updated based on the identified at least one action. In certain examples, the virtual session may be dynamically updated based on the at least one action prior to completing the authentication of the user.

In certain examples, at least one of the received workflow events may include a workflow event indicating that an access token associated with the user has been received at a workflow device in communication with one or more of the terminal devices.

In certain examples, at least one of the workflow events based on which the authentication flow is selected may be a workflow event associated with a second user and a second virtual session. For example, as discussed with reference to FIG. 3C, a rule may allow a second user to access his or her virtual session at a terminal device using single-factor authentication based on the fact that a first user is currently logged in to that terminal device. Thus, a workflow event received at the central server computer system 110-e when the first user logs in to the terminal device (e.g., upon providing an access token to a workflow device, upon entering a password to the terminal device, etc.) may affect the authentication flow selected for the second user.

The user authentication module 420 may authenticate the user at one of the terminal devices according to the authentication flow determined by the authentication flow module 415. Following authentication, the central server computer system 110-e may selectively transmit session data (e.g., user interface and/or KVM data, commands, etc.) for the virtual session between the central server computer system and the terminal device through which the user has been authenticated.

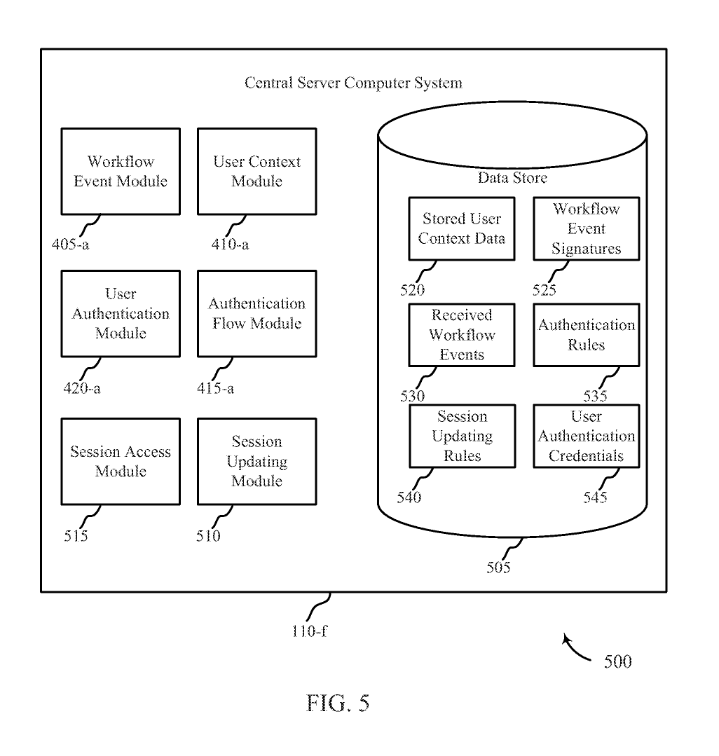

FIG. 5 is a block diagram 500 of a more detailed example of a central server computer system 110-f according to the principles of the present description. The central server computer system 110-f may be an example of one or more of the central server computer systems 110 described above with reference to the previous Figures. The central server computer system 110-f of FIG. 5 may include a workflow event module 405-a, a user context module 410-a, an authentication flow module 415-a, a user authentication module 420-a, a data store 505, a session updating module 510, and a session access module 515. Each of these components may be in communication with each other component, directly or indirectly. In certain examples, the components and modules 405-a, 410-a, 415-a, 420-a, 505, 510, 515 shown in FIG. 5 may be implemented as part of the workflow event processing module 210 of FIG. 2.

Each of the components and modules 405-a, 410-a, 415-a, 420-a, 505, 510, 515 shown in FIG. 5 may be implemented by dedicated hardware, processor hardware executing software, software stored on a physical computer-readable medium or device, or combinations thereof In certain examples, the same hardware may implement more than one of the components or modules of FIG. 4. Additionally or alternatively, the functionality of the components or modules of the central server computer system 110-e may be distributed across a system of interrelated hardware devices.

The workflow event module 405-a, user context module 410-a, authentication flow module 415-a, and user module 420-a may perform substantially the same functionality described above with respect to their counterparts in FIG. 4. The data store 505 may be configured to store stored user context data 520 for use by the user context module 410-a to determine a current context of a user, workflow event signatures 525 associated with authentication rules 535 for dynamically updating authentication flows and rules for session updating rules 540 for dynamically updating virtual sessions, a buffer of received workflow events 530, and stored user authentication credentials 545 for comparison to credentials provided by the user to the user authentication module 420-a.

When a sequence of received workflow events matches a stored workflow event signature 525, one or more of the authentication rules 535 or the session updating rules 540 may be triggered at the authentication flow module 415-a and/or the session updating module 510. One or more actions associated with each triggered rule may be enforced to dynamically update the authentication flow for the user and/or dynamically update the virtual session of the user prior to the authentication of the user.

If the user provides credentials matching the stored user authentication credentials 545 for that user in accordance with the determined authentication flow, the user authentication module 420-a may confirm the identity of the user, thereby allow the session access module 515 to selectively transmit and receive session data to and from the user at the terminal device.

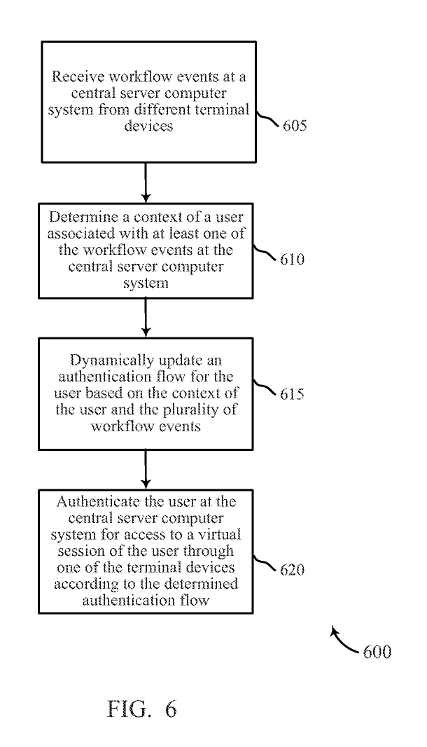

FIG. 6 illustrates a flowchart of an example method 600 of managing virtual sessions in accordance with the principles of the present description. The method 600 may be performed, for example, by one or more of the central server computer systems 110 described above with reference FIGS. 1-5.

At block 605, a number of workflow events may be received (e.g., over a network) at a central server computer system from different terminal devices of a plurality of terminal devices. A context of a user associated with at least one of the workflow events may be determined at block 610. At block 615, an authentication flow for the user may be dynamically updated based on the context of the user and the received workflow events. In certain examples, determining the authentication flow may include determining a number of factors to use for authentication of the user (e.g., single-factor vs. dual-factor authentication). At block 620, the user may be authenticated at the central server computer system for access to a virtual session associated with the user through one of the terminal devices according to the determined authentication flow.

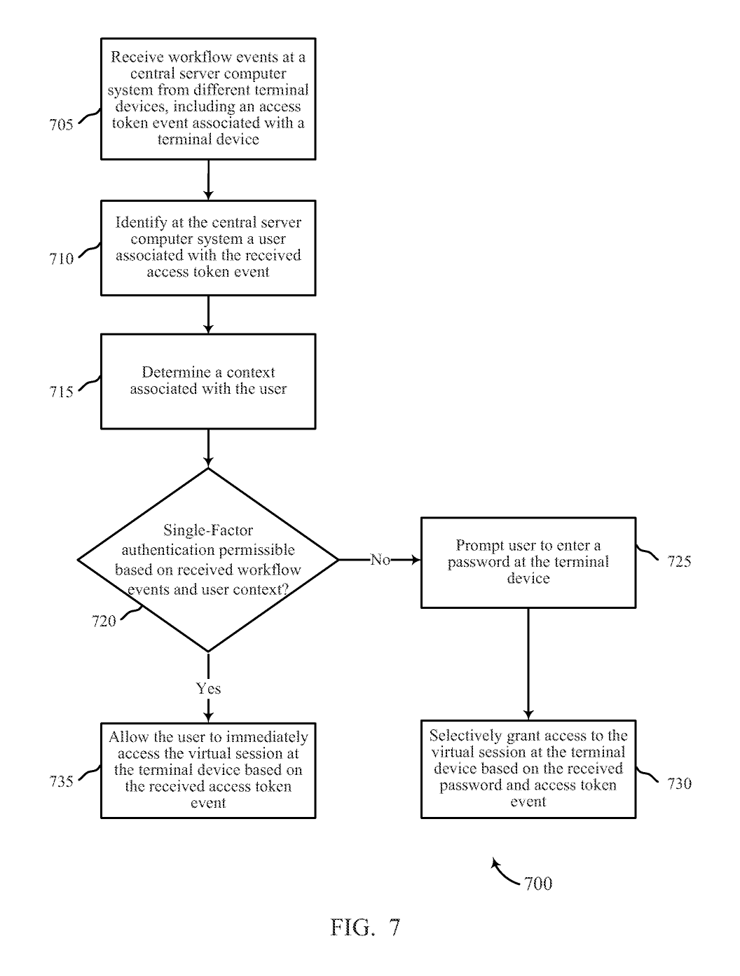

FIG. 7 illustrates a flowchart of an example method 700 of managing virtual sessions in accordance with the principles of the present description. The method 700 may be performed, for example, by one or more of the central server computer systems 110 described above with reference FIGS. 1-5. The method 700 of FIG. 7 may be an example of the method 600 of FIG. 6.

At block 705, workflow events may be received (e.g., over a network) at a central server computer system from different terminal devices. The received workflow events may include an access token event received from a terminal device. The access token event may indicate that the terminal device has received an access token at a workflow device associated with the terminal device. At block 710, a user associated with the received access token event may be identified at the central server computer system. At block 715, a context of the identified user may be determined

At block 720, a determination may be made as to whether single-factor authentication is permissible for access to a virtual session of the identified user. The determination may be made based on at least the received workflow events and the determined user context. If single-factor authentication is permissible (block 720, Yes), the user may be permitted to immediately access the virtual session at the terminal device based on the received access token event. If single-factor authentication is not permissible (block 720, No), at block 725 the user may be prompted to enter a password at the terminal device. At block 730, the central server computer system may authenticate the user by selectively granting access to the virtual session of the user at the terminal device based on the received password and access token event.

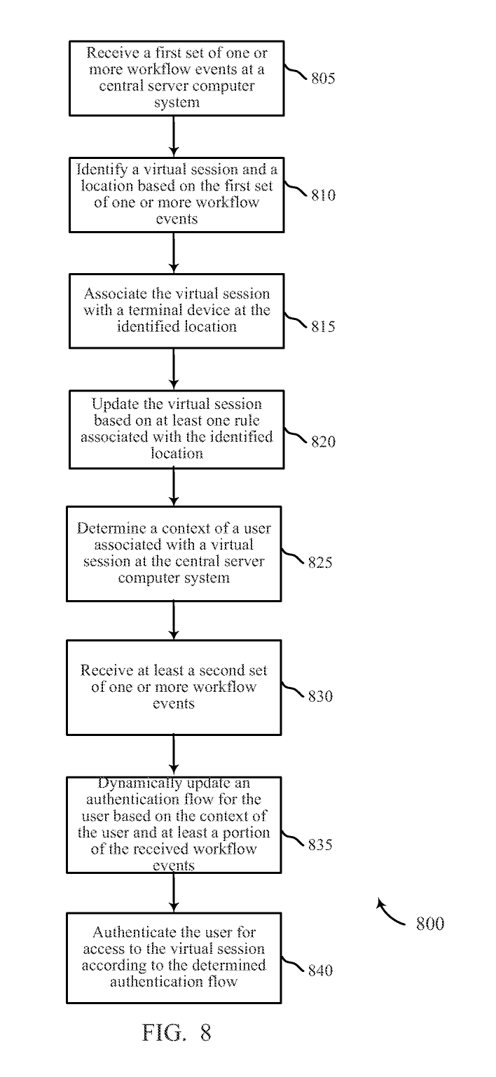

FIG. 8 illustrates a flowchart of an example method 800 of managing virtual sessions in accordance with the principles of the present description. The method 800 may be performed, for example, by one or more of the central server computer systems 110 described above with reference FIGS. 1-5. The method 800 of FIG. 8 may be an example of one or more of the method 600 of FIG. 6 or the method 700 of FIG. 7.

At block 805, a first set of one or more workflow events may be received at a central server computer system. In certain examples, multiple workflow events may be received from different terminal devices. At block 810, a virtual session and a location may be identified based on the first set of one or more workflow events. At block 815, the virtual session may be associated with a terminal device at the identified location, and at block 820, the virtual session may be updated based on at least one rule associated with the identified location.

At block 825, a context of a user associated with the identified virtual session and the first set of workflow events may be determined at the central server computer system. At block 830, at least a second set of one or more workflow events may be received. In certain examples, the workflow events may be received from different terminal devices. At block 835, an authentication flow for the user may be dynamically updated based on the context of the user and at least a portion of the second set of workflow events. At block 840, the user may be authenticated for access to the virtual session at the terminal device associated with the identified location according to the determined authentication flow.

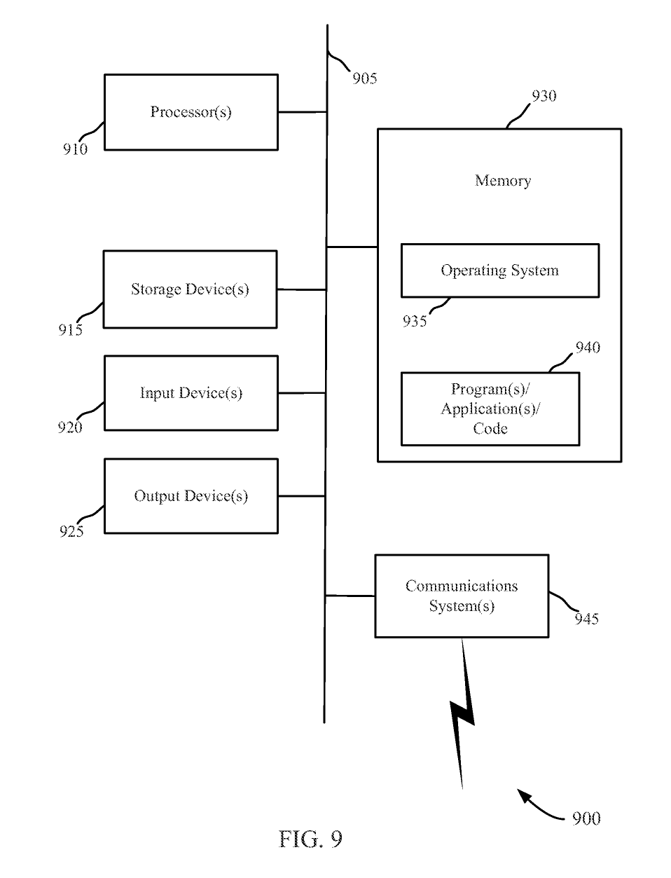

A device structure 900 that may be used for a host device 105, a central server computer system 110, a rules engine 115, a terminal device 120, or other computing devices described herein, is illustrated with the schematic diagram of FIG. 9. This drawing broadly illustrates how individual system elements of each of the aforementioned devices may be implemented, whether in a separated or more integrated manner. The exemplary structure is shown comprised of hardware elements that are electrically coupled via bus 905, including processor(s) 910 (which may further comprise a DSP or special-purpose processor), storage device(s) 915, input device(s) 920, and output device(s) 925. The storage device(s) 915 may be a machine-readable storage media reader connected to any machine-readable storage medium, the combination comprehensively representing remote, local, fixed, or removable storage devices or storage media for temporarily or more permanently containing computer-readable information. The communications systems interface 945 may interface to a wired, wireless, or other type of interfacing connection that permits data to be exchanged with other devices. The communications system(s) interface 945 may permit data to be exchanged with a network.

The structure 900 may also include additional software elements, shown as being currently located within working memory 930, including an operating system 935 and other code 940, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

These components may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined.

Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a SIM card, other smart cards, and various other mediums capable of storing, containing or carrying instructions or data.

Furthermore, embodiments may be implemented by hardware, software, firmware, middleware, microcode, hardware description languages, or any combination thereof When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of managing virtual sessions, comprising:
receiving a plurality of workflow events at a central server computer system from different terminal devices of a plurality of terminal devices;
determining a context of a user associated with at least one of the workflow events at the central server computer system;
dynamically updating an authentication flow for the user based on the context of the user and at least one of the received workflow events; and
authenticating the user at the central server computer system for access to a virtual session of the user through one of the terminal devices according to the determined authentication flow.

2. The method of claim 1, wherein the dynamically updating the authentication flow comprises:
selecting between a single-factor authentication flow and a dual-factor authentication flow for the user based on the received workflow events.

3. The method of claim 2, further comprising:
comparing the received workflow events to a stored sequence of workflow events.

4. The method of claim 3, further comprising:
determining that the received workflow events match the stored sequence of workflow events; and
triggering an authentication rule associated with the stored sequence of workflow events based on the determined match.

5. The method of claim 3, wherein the stored sequence of events comprises a time constraint associated with a receipt of at least two of the workflow events in the stored sequence of workflow events.

6. The method of claim 1, further comprising:
identifying at least one action associated with the virtual session based at least in part on the received workflow events; and
dynamically updating the virtual session based on the at least one action.

7. The method of claim 6, wherein the virtual session is dynamically updated based on the at least one action prior to completing the authentication of the user.

8. The method of claim 1, wherein the at least one of the workflow events based on which the authentication flow is selected comprises a workflow event associated with a second user and a second virtual session.

9. The method of claim 1, wherein the received workflow events comprise at least one workflow event indicating that an access token associated with the user has been received at a workflow device in communication with one of the terminal devices.

10. The method of claim 9, further comprising:
selectively transmitting session data for the virtual session between the central server computer system and the one of the terminal devices in response to the authentication of the user.

11. A central server computer system configured to manage access tokens, the central server computer system comprising:
a workflow event receiving module configured to receive a plurality of workflow events at a central server computer system from a plurality of different terminal devices;
a user context module configured to determine a context of a user associated with a virtual session at the central server computer system;
an authentication flow module configured to dynamically update an authentication flow for the user based on the context of the user and at least one of the received workflow events; and
a user authentication module configured to authenticate the user for access to the virtual session at a terminal device according to the determined authentication flow.

12. The system of claim 11, wherein the authentication flow module is further configured to:
select between a single-factor authentication flow and a dual-factor authentication flow for the user based on the received workflow events.

13. The system of claim 12, wherein the authentication flow module is further configured to:
compare the received workflow events to a workflow event signature to select one of the single-factor authentication flow or the dual-factor authentication flow.

14. The system of claim 13, wherein the authentication flow module is further configured to:
determine that the received workflow events match the stored sequence of workflow events; and
trigger an authentication rule associated with the stored sequence of workflow events based on the determined match.

15. The method of claim 13, wherein the stored sequence of events comprises a time constraint associated with a receipt of at least two of the workflow events in the stored sequence of workflow events.

16. The system of claim 11, further comprising a session updating module configured to:
identify at least one action associated with the virtual session based at least in part on the received workflow events; and
dynamically update the virtual session based on the at least one action.

17. The system of claim 16, wherein the session updating module is configured to dynamically updated the virtual session based on the at least one action prior to completing the authentication of the user.

18. The system of claim 11, wherein the at least one of the workflow events based on which the authentication flow is selected comprises a workflow event associated with a second user and a second virtual session.

19. The system of claim 11, wherein the received workflow events comprise at least one workflow event indicating that an access token associated with the user has been received at a workflow device in communication with one of the terminal devices.

20. The system of claim 11, further comprising a session access module configured to:
selectively transmit session data for the virtual session between the central server computer system and the one of the terminal devices in response to the authentication of the user.

21. A computer program product, comprising:
a tangible computer readable device comprising computer readable instructions stored thereon, the computer readable program instructions comprising:
computer readable program instructions configured to receive a plurality of workflow events at a central server computer system from a plurality of different terminal devices;
computer readable program instructions configured to determine a context of a user associated with a virtual session at the central server computer system;
computer readable program instructions configured to dynamically update an authentication flow for the user based on the context of the user and at least one of the received workflow events; and
computer readable program instructions configured to authenticate the user for access to the virtual session at a terminal device according to the determined authentication flow.
